(19) United States
(12) Patent Application Publication
(10) Pub. No.: US 2022/0082225 A1
(43) Pub. Date: Mar. 17, 2022

(54) LASER PHOSPHOR LIGHT SOURCE FOR INTELLIGENT HEADLIGHTS AND SPOTLIGHTS

(71) Applicant: Optonomous Technologies, Inc., Agoura Hills, CA (US)

(72) Inventors: Yung Peng Chang, Hsinchu (TW); Alan Wang, Taichung (TW); Kirk Huang, Taichung (TW); Mark Chang, Taichung (TW); Lion Wang, Hsinchu (TW); Andy Chen, Taichung (TW); Kenneth Li, Agoura Hills, CA (US)

(21) Appl. No.: 17/282,322

(22) PCT Filed: Oct. 4, 2019
(86) PCT No.: PCT/US2019/054898

§ 371 Date: Apr. 1, 2021

Related U.S. Application Data
(60) Provisional application No. 62/766,209, filed on Oct. 5, 2018.

(51) Int. Cl. F21S 41/176; F21S 45/47; F21S 41/16; F21S 41/32; F21S 41/148; F21S 41/20; F21S 41/36

(52) U.S. Cl. CPC F21S 41/176; F21S 45/47; F21S 41/16; F21S 41/36; F21S 41/148; F21S 41/285; F21S 41/321

(57) ABSTRACT

A laser-excited phosphor light source and method includes a heat sink; a plurality of lasers, each mounted in thermal contact to the heat sink, wherein each of the plurality of lasers emits one or more first (e.g., blue) wavelengths. A crystal phosphor rod having two ends and at least one side face is operatively coupled to receive the laser light from one or more of the plurality of lasers. The rod emits light of one or more longer wavelengths. A compound parabolic concentrator (CPC) receives the light from the crystal phosphor rod. The light source outputs an output light beam that includes the light of one or more longer wavelengths from the first crystal phosphor rod and light of the one or more first (e.g., blue) wavelengths. Some embodiments include multiple phosphor light sources of different colors, and/or a blue light source not using phosphors.

### CROSS-REFERENCE TO RELATED APPLICATIONS

This application claims priority benefit, including under 35 U.S.C. § 119(e), of U.S. Provisional Patent Application No. 62/766,209, filed Oct. 5, 2018 by Y. P. Chang et al., titled “Laser Phosphor Light Source for Intelligent Headlights and Spotlights,” which is incorporated herein by reference in its entirety.

This application is related to:
PCT Patent Application PCT/US2019/037231 titled “ILLUMINATION SYSTEM WITH HIGH INTENSITY OUTPUT MECHANISM AND METHOD OF OPERATION THEREOF”, filed Jun. 14, 2019, by Y. P. Chang et al.;
U.S. patent application Ser. No. 16/509,085 titled “ILLUMINATION SYSTEM WITH CRYSTAL PHOSPHOR MECHANISM AND METHOD OF OPERATION THEREOF”, filed Jul. 11, 2019, by Y. P. Chang et al.;
U.S. patent application Ser. No. 16/509,196 titled “ILLUMINATION SYSTEM WITH HIGH INTENSITY PROJECTION MECHANISM AND METHOD OF OPERATION THEREOF”, filed Jul. 11, 2019, by Y. P. Chang et al.;
U.S. Provisional Patent Application 62/837,077 titled “LASER EXCITED CRYSTAL PHOSPHOR SPHERE LIGHT SOURCE”, filed Apr. 22, 2019, by Kenneth Li et al.;
U.S. Provisional Patent Application 62/853,538 titled “LIDAR INTEGRATED WITH SMART HEADLIGHT USING A SINGLE DMD”, filed May 28, 2019, by Y. P. Chang et al.;
U.S. Provisional Patent Application 62/856,518 titled “VERTICAL CAVITY SURFACE EMITTING LASER USING DICHROIC REFLECTORS”, filed Jul. 8, 2019, by Kenneth Li et al.;
U.S. Provisional Patent Application 62/871,498 titled “LASER-EXCITED PHOSPHOR LIGHT SOURCE AND METHOD WITH LIGHT RECYCLING”, filed Jul. 8, 2019, by Kenneth Li;
U.S. Provisional Patent Application 62/857,662 titled “SCHEME OF LIDAR-EMBEDDED SMART LASER HEADLIGHT FOR AUTONOMOUS DRIVING”, filed Jun. 5, 2019, by Chun-Nien Liu et al.;
U.S. Provisional Patent Application 62/873,171 titled “SPECKLE REDUCTION USING MOVING MIRRORS AND RETRO-REFLECTORS”, filed Jul. 11, 2019, by Kenneth Li;
U.S. Provisional Patent Application 62/862,549 titled “ENHANCEMENT OF LED INTENSITY PROFILE USING LASER EXCITATION”, filed Jun. 17, 2019, by Kenneth Li;
U.S. Provisional Patent Application 62/874,943 titled “ENHANCEMENT OF LED INTENSITY PROFILE USING LASER EXCITATION”, filed Jul. 16, 2019, by Kenneth Li;
U.S. Provisional Patent Application 62/881,927 titled “SYSTEM AND METHOD TO INCREASE BRIGHTNESS OF DIFFUSED LIGHT WITH FOCUSED RECYCLING”, filed Aug. 1, 2019, by Kenneth Li;
U.S. Provisional Patent Application 62/895,367 titled “INCREASED BRIGHTNESS OF DIFFUSED LIGHT WITH FOCUSED RECYCLING”, filed Sep. 3, 2019, by Kenneth Li; and
U.S. Provisional Patent Application 62/903,620 titled “RGB LASER LIGHT SOURCE FOR PROJECTION DISPLAYS”, filed Sep. 20, 2019, by Lion Wang et al.; each of which is incorporated herein by reference in its entirety.

### FIELD OF THE INVENTION

This invention relates to the field of light sources, and more specifically to a method and apparatus for generating high-intensity light having both blue light from one or more lasers and/or light-emitting diode (LED) as well as luminescent light that is frequency-down-converted from blue laser light using phosphor(s) in crystal form.

### BACKGROUND OF THE INVENTION

PCT Patent Application PCT/US2019/037231, which is incorporated by reference, describes an illumination system that includes a waveguide having a first end configured to receive a laser light, a luminescent portion configured to generate a luminescent light from the laser light, a second end opposite the first end configured to pass the luminescent light; an input device adjacent to the first end configured to collect the laser light for propagation to the first end; an output device adjacent to the second end configured to reflect at least some of the laser light back into the luminescent portion and direct the luminescent light away from the second end through an output surface. In one embodiment, the input device includes a light homogenizer configured to receive the laser light and provide to the first end of the waveguide a spatially uniform intensity distribution of the laser light. In another embodiment, a heat dissipater is provided adjacent to the waveguide and configured to dissipate heat generated within the waveguide by the generation of the luminescent light.

U.S. patent application Ser. No. 16/509,085, which is incorporated by reference, describes an illumination system that includes: a laser array assembly including: a laser configured to generate a laser light; a crystal phosphor waveguide, adjacent to the laser and in the laser light, configured to: generate of a luminescent light based on receiving the laser light, and direct the luminescent light away from a base end; and a compound parabolic concentrator (CPC), coupled to the crystal phosphor waveguide opposite the base end, configured to: collect the luminescent light from the crystal phosphor waveguide, extract the luminescent light away from the crystal phosphor waveguide.

U.S. patent application Ser. No. 16/509,196, which is incorporated by reference, describes an illumination system that includes an input device configured to generate a first luminescent light beam; a pumping assembly, optically coupled to the input device, configured to project a pumping light beam into the input device; a focusing lens, aligned with the first luminescent light beam, to focus the first luminescent light beam enhanced by the pumping light beam as an output beam; and an output device, optically coupled to the focusing lens, configured to: receive the output beam from the focusing lens, and project an application output, formed with the output beam, from a projection device.

U.S. Pat. No. 5,727,108 to Hed issued on Mar. 10, 1998 with the title “High efficiency compound parabolic concentrators and optical fiber powered spot luminaire,” and is incorporated by reference. U.S. Pat. No. 5,727,108 describes a compound parabolic concentrator (CPC) that can be used as an optical connector or in a like management system or simply as a concentrator or even as a spotlight. That CPC has a hollow body formed with an input aperture and an output aperture and a wall connecting the input aperture with the output aperture and diverting from the smaller of the cross sectional areas to the larger cross sectional areas of the apertures. The wall is composed of contiguous elongated prisms of a transparent dielectric material so that the single reflection from the inlet aperture to the outlet aperture takes place within the prisms and thus the losses of purely reflective reflectors can be avoided.

A journal article titled “Optical efficiency study of PV Crossed Compound Parabolic Concentrator,” by Nazmi Sellami and Tapas K. Mallick (Applied Energy, February, 2013, Vol. 102, 868-876) (which is incorporated herein by reference), describes static solar concentrators that present a solution to the challenge of reducing the cost of Building Integrated Photovoltaic (BIPV) by reducing the area of solar cells. In this study a 3-D ray trace code has been developed using MATLAB in order to determine the theoretical optical efficiency and the optical flux distribution at the photovoltaic cell of a 3-D Crossed Compound Parabolic Concentrator (CCPC) for different incidence angles of light rays.

There is a need in the art for a high-luminance light source having a plurality of colors.

### SUMMARY OF THE INVENTION

The present invention provides a laser-excited phosphor light source combined with blue light and corresponding methods.

In the lighting industry, the brightness of a light source is one of the most important and most fundamental parameters that is representative of the light source. For example, arc lamps are brighter than halogen lamps and halogen lamps are brighter than incandescent lamps. Light-emitting-diode (LED) light sources are able to fill in the region between the arc lamps and the halogen lamps and as a result, they are not suitable for many high-brightness applications. Only recently, laser-excited phosphor light sources have started to have increased brightness that increased the number of applications and expanded the use of LEDs in many markets. The heat sinking of the phosphor portion of the light source remains a major issue for high-power and high-efficiency operations. The present invention discloses a lighting system where light from a laser-excited crystal phosphor rod system is mixed with a blue light source—which, in various embodiments, can be an LED light source or a laser light source—such that a white-light output beam is produced with controlled amount of blue light, achieving light output with a selected (and/or selectable) desired color temperature.

Some embodiments include a laser-excited phosphor light source and method that include a heat sink; a plurality of lasers, each mounted in thermal contact to the heat sink, wherein each of the plurality of lasers emits one or more first (e.g., blue) wavelengths. A crystal phosphor rod having two ends and at least one side face is operatively coupled to receive the laser light from one or more of the plurality of lasers. The rod emits light of one or more longer wavelengths. A compound parabolic concentrator (CPC) receives the light from the crystal phosphor rod. In some embodiments, the CPC includes a structure such as described in journal article “Optical efficiency study of PV Crossed Compound Parabolic Concentrator,” by Nazmi Sellami and Tapas K. Mallick (cited above). The light source outputs an output light beam that includes the light of one or more longer wavelengths from the first crystal phosphor rod and light of the one or more first (e.g., blue) wavelengths. Some embodiments include multiple phosphor light sources of different colors, and/or a blue light source not using phosphors.

### BRIEF DESCRIPTION OF THE DRAWINGS

FIG. 1 is a cross-sectional block diagram of a system 100 using a laser-excited crystal phosphor rod system 110 with compound parabolic concentrator (CPC) beam shaper 113, a blue-light LED source 150 with lens system 140, and a frequency-selective reflector 130 that uses a frequency-selective optical filter-reflector 131, according to some embodiments of the present invention.

FIG. 2 is a cross-sectional block diagram of a system 200 using a laser-excited crystal phosphor rod system 110 with CPC beam shaper 113, a blue-light LED source 150 with lens system 140, and a frequency-selective reflector 230 that uses an air gap 232 to promote total internal reflection (TIR) in the crystal phosphor rod system 110, according to some embodiments of the present invention.

FIG. 3 is a cross-sectional block diagram of a system 300 using a laser-excited crystal phosphor rod system 110 with CPC beam shaper 113, a blue-light LED source 150 with CPC beam shaper 340, and a frequency-selective reflector 130 that uses a frequency-selective optical filter-reflector 131, according to some embodiments of the present invention.

FIG. 4 is a cross-sectional block diagram of a system 400 using a laser-excited crystal phosphor rod system 110 with CPC beam shaper 113, a blue-light LED source 150 with CPC beam shaper 340, and a frequency-selective reflector 230 that uses an air gap 232 to promote total internal reflection (TIR) in the crystal phosphor rod system 110, according to some embodiments of the present invention.

FIG. 5A is a cross-sectional block diagram of a system 500 using a laser-excited crystal phosphor rod system 110 with CPC beam shaper 113, a blue-light laser source 550 with CPC beam shaper 340, and a frequency-selective reflector 130 that uses a frequency-selective optical filter-reflector 131, according to some embodiments of the present invention.

FIG. 5B is a perspective block diagram of a spatial filter 553, according to some embodiments of the invention.

FIG. 6 is a cross-sectional block diagram of a system 600 using a laser-excited crystal phosphor rod system 110 with CPC beam shaper 113, a blue-light laser source 550 with CPC beam shaper 340, and a frequency-selective reflector 230 that uses an air gap 232 to promote total internal reflection (TIR) in the crystal phosphor rod system 110, according to some embodiments of the present invention.

FIG. 7A is a cross-sectional block diagram of a system 701 using a laser-excited crystal phosphor rod system 710 with CPC beam shaper 113, a blue-light laser source array 720, and a frequency-selective reflector 730, according to some embodiments of the present invention.

FIG. 7B is a cross-sectional block diagram of a system 702 using a laser-excited crystal phosphor rod system 710 with CPC beam shaper 113, a blue-light laser source array 720 with a diffuser 754 and/or spatial filter 753, and a frequency-selective reflector 730, according to some embodiments of the present invention.

FIG. 8A is a cross-sectional block diagram of a system 801 using a laser-excited segmented crystal phosphor rod system 810 with CPC beam shaper 113, a blue-light laser source array 820, and an additional blue laser source 852 prism reflector 832 and a frequency-selective reflector 811, according to some embodiments of the present invention.

FIG. 8B is a cross-sectional block diagram of a system 802 using a laser-excited segmented crystal phosphor rod system 810′ (which uses segments, each with different phosphors, which absorb blue light and down-convert the frequency of light to one or more of a plurality of different color wavelengths) with CPC beam shaper 113, a blue-light laser source array 820′, and an additional blue laser source 852 prism reflector 832 and a frequency-selective reflector 811, according to some embodiments of the present invention.

FIG. 8C is a cross-sectional block diagram of a system 803 using a laser-excited segmented crystal phosphor rod system 810 with CPC beam shaper 113, a blue-light laser source array 820, and an additional blue laser source 852, angled reflector 833 and a frequency-selective reflector 811, according to some embodiments of the present invention.

FIG. 9A is a cross-sectional block diagram of a system 901 using a laser-combining prism-top glass rod system 910 with CPC beam shaper 113, and a blue-light laser source array 920, according to some embodiments of the present invention.

FIG. 9B is a cross-sectional block diagram of a system 902 using a laser-combining prism-top glass rod system 910′ with CPC beam shaper 113, and a blue-light laser source array 920, according to some embodiments of the present invention.

FIG. 9C is a perspective block diagram of a system 903 using a laser-combining prism-top-and-side glass rod system 940 with CPC beam shaper 113, and blue-light laser source arrays 925 and 926, according to some embodiments of the present invention.

FIG. 10 is a cross-sectional block diagram of a blue-light system 1000 using a prism-top crystal rod system 1010 with CPC beam shaper 113, and a blue-light laser source array 1020, according to some embodiments of the present invention.

FIG. 11 is a perspective block diagram of a four-color light-source system 1100 using a blue-light system 1000, along with a plurality of crystal phosphor rod systems 1110, 1120, 1130 using blue-laser pumps and outputting different color output with CPC beam shapers and heat sink 1111, according to some embodiments of the present invention.

FIG. 12A is an exploded perspective block diagram of a four-color light-source system 1200 using a four-color light-source system 1100 and a plurality of heat sinks 1210 and 1220, according to some embodiments of the present invention.

FIG. 12B is a perspective block diagram of a four-color light-source system 1200 using a four-color light-source system 1100 and a plurality of heat sinks 1210 and 1220, according to some embodiments of the present invention.

FIG. 13 is a block diagram of a vehicle system 1300 using a light-source system 1320 in a vehicle 1310, according to some embodiments of the present invention.

FIG. 14 is a block diagram of an image-projection system 1400 using a light-source system 1420 in a projector 1410, according to some embodiments of the present invention.

### DESCRIPTION OF PREFERRED EMBODIMENTS OF PART A OF THE INVENTION

Although the following detailed description contains many specifics for the purpose of illustration, a person of ordinary skill in the art will appreciate that many variations and alterations to the following details are within the scope of the invention. Specific examples are used to illustrate particular embodiments; however, the invention described in the claims is not intended to be limited to only these examples, but rather includes the full scope of the attached claims. Accordingly, the following preferred embodiments of the invention are set forth without any loss of generality to, and without imposing limitations upon the claimed invention. Further, in the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The embodiments shown in the Figures and described here may include features that are not included in all specific embodiments. A particular embodiment may include only a subset of all of the features described, or a particular embodiment may include all of the features described.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

Certain marks referenced herein may be common-law or registered trademarks of third parties affiliated or unaffiliated with the applicant or the assignee. Use of these marks is for providing an enabling disclosure by way of example and shall not be construed to limit the scope of the claimed subject matter to material associated with such marks.

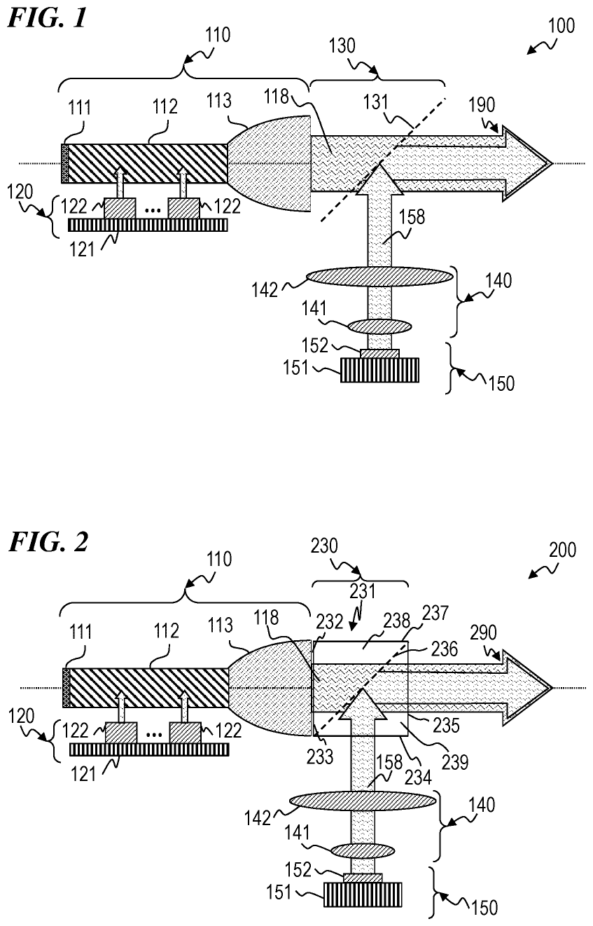

FIG. 1 is a cross-sectional block diagram of a system 100 using a laser-excited crystal phosphor rod system 110 with compound parabolic concentrator (CPC) beam shaper 113, a blue-light LED source 150 with lens system 140, and a frequency-selective filter-reflector beam combiner 130 that uses a frequency-selective optical filter-reflector 131, according to some embodiments of the present invention.

In some embodiments, a crystal phosphor rod 112 with yellow-light-emitting phosphor is excited by one or more blue lasers (e.g., in some embodiments, a laser array 120 having a plurality of blue-light lasers 122 mounted on a heat sink 121) that emit laser light into rod 112 from one or more sides of the rod 112. In other embodiments, crystal rod 112 includes a plurality of phosphors in addition to, or as an alternative to, yellow-light-emitting phosphors, such as red-light-emitting and green-light-emitting phosphors in order to provide improved color rendering.

In some embodiments, a reflector 111 is attached to the base end of rod 112 (at the left end in the FIG. 1), and a compound parabolic concentrator (CPC) 113 is optically coupled to the light-output end of crystal phosphor rod 112 opposite the base end. CPC 113 is configured to collect the luminescent light from the crystal phosphor rod 112, and project the luminescent light 118 away from the crystal phosphor waveguide 110. In some embodiments, a CPC 113 is used at the output end of the crystal phosphor rod 112, coupling the light output with a higher efficiency and a lower divergence angle than alternative output coupling devices. An end reflector 111 is used to reflect light propagating towards the left back into the rod 112 for emission toward the right in the Figure through the front end of rod 112.

In some embodiments, since the light from crystal rod 112 is primarily composed of longer wavelengths than the blue laser light used to pump the phosphors in crystal rod 112, in order to provide the needed blue light for the adjustment of color temperature, a blue LED assembly 150, which includes a heat sink 151 and one or more blue LEDs 152, is used together with collimating lens assembly 140 (which, in some embodiments, includes lenses 141 and 142, for the adjustment of the output divergence angle of the blue light from blue LED assembly 150, such that the blue light matches with the output divergence angle of the CPC 113. The light outputs 118 and 158 are then combined into a single output 190 using wavelength combiner 130 that includes frequency-selective reflecting filter-reflector 131, which transmits longer wavelengths, such as yellow light (or, in other embodiments, red, orange, yellow and/or green light) and reflects shorter wavelengths such as blue light. In some embodiments, the color temperature (i.e., the relative amounts of longer wavelengths and shorter wavelengths) is adjustable by varying the amount of blue light from blue LED assembly 150 as compared to the longer wavelengths from laser-excited crystal phosphor rod system 110. In some embodiments, the output white light is used as the light source for automotive headlight applications. In some other embodiments, the output white light is used to illuminate an imager or projector in the automotive headlights, such as a digital light projector (DLP, for example, in some embodiments, Texas Instruments' DLP® digital mirror display (DMD)), a liquid-crystal display (LCD) imager/projector, or liquid-crystal-on-silicon (LCOS) imager/projector, such that the shape of the spatial output-light pattern can be changed according to the needs of the road conditions.

In some embodiments, the crystal phosphor rod 112 includes a glass-phosphor rod or any other suitable optical waveguide with fluorescent materials embedded in it. In some embodiments, CPC 113 is hollow, while in other embodiments, CPC 113 is a transparent solid. In some embodiments, when a solid CPC 113 is used, transparent optical epoxy or glue is used between the rod 112 and the CPC 113 such that reflections at the interface between crystal rod 112 and CPC 113 will be minimized. In some embodiments, end reflector 111 includes an individual reflector placed next to the rod 112, while in other embodiments, end reflector 111 is a reflective coating deposited directly on the rod 112.

Although for illustrative purposes in the figures, the arrows indicating the shorter-wavelength (e.g., blue) light beam and the longer-wavelength (e.g., yellow) light beam are shown with different widths, in some preferred embodiments, the propagation axis, shape, size and divergence angles of the two beams are made equal or substantially equal, such that the color temperature of the light across the area of the beam is substantially constant.

FIG. 2 is a cross-sectional block diagram of a system 200 using a laser-excited crystal phosphor rod system 110 with CPC beam shaper 113, a blue-light LED source 150 with lens system 140, and a frequency-selective prism-assembly beam combiner 230 that uses an air gap 232 to promote total internal reflection (TIR)-like functionality in the crystal phosphor rod system 110, according to some embodiments of the present invention, which shows another embodiment in which the frequency-selective optical filter-reflector 131 is replaced by prism assembly 231, in which a frequency-selective optical filter-reflector 236 between the prisms 238 and 239 is used as shown, passing the longer-wavelength (e.g., yellow) light 118 and reflecting the shorter-wavelength (e.g., blue) light 158 from the blue LED 152. The two prisms 238 and 239, together with the frequency-selective optical filter coating 236 (shown as a dashed line), form a prism-assembly beam combiner 230. In some embodiments, the use of such beam combiner 230 reduces the dimensions of the components and of system 200 as compared to system 100 of FIG. 1. In some embodiments, the air gap 232 between the phosphor rod system 110 and the beam combiner 230 is used to promote total internal reflections (TIR) such that the beam combiner 230 also acts as a waveguide, guiding the yellow light from input face 233 and the blue light from input face 234 to output face 235 for coupling the combined output light 290 to the external applications. In some embodiments, blue LED assembly 150 (which includes heat sink 151 and blue LED 152) is used together with collimating lens assembly 140 (which includes collimating lenses 141 and 142), as described above for FIG. 1.

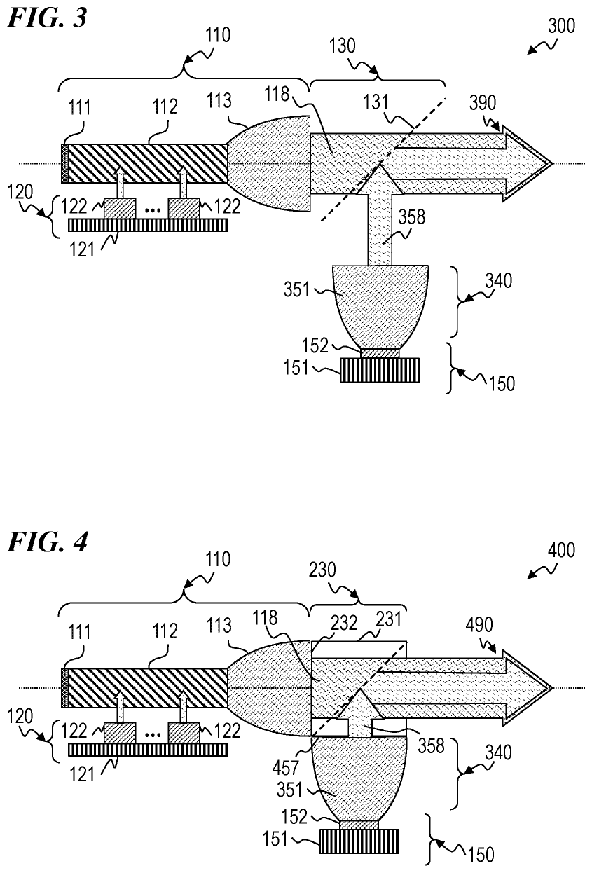

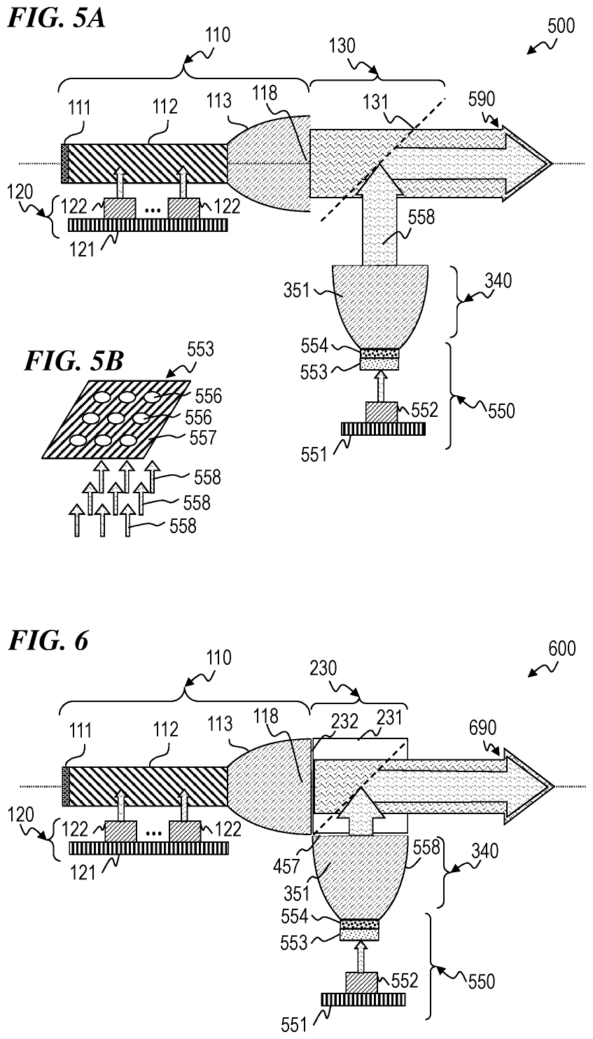

In other embodiments (not shown), prism-assembly beam combiner 230 is configured to transmit the shorter-wavelength (e.g., blue) light upward and to reflect the longer-wavelength (e.g., yellow) light upward such that the combined output beam is emitted from face 237 (the top face in FIG. 2) of beam combiner 230. The present invention includes similar alternative embodiments (using frequency-selective optical filter-reflectors that transmit the shorter-wavelength (e.g., blue) light upward and reflect the longer-wavelength (e.g., yellow) light upward) for FIG. 1, FIG. 3, FIG. 4, FIG. 5, and FIG. 6.

FIG. 3 is a cross-sectional block diagram of a system 300 using a laser-excited crystal phosphor rod system 110 with CPC beam shaper 113, a blue-light LED source 150 with CPC beam shaper 340, and a frequency-selective filter-reflector beam combiner 130 that uses a frequency-selective optical filter-reflector 131, according to some embodiments of the present invention. System 300 is yet another embodiment, where the output of blue LED assembly 150 (rather than being shaped by collimating lens assembly 140) is coupled through a CPC 340 (in some embodiments, CPC 340 is substantially the same as CPC 113 used for the crystal phosphor rod 112), such that the output divergences of the longer-wavelength (e.g., yellow) light 118 and the shorter-wavelength (e.g., blue) light 358 are substantially the same. In some embodiments, the outputs are then combined into a single output light beam 390 using the frequency-selective filter-reflector beam combiner 130, which passes the yellow light and reflects the blue light. In some embodiments, the cross-section dimensions of the blue LED 152 are made substantially the same as the cross-section output end of the phosphor rod 112.

FIG. 4 is a cross-sectional block diagram of a system 400 using a laser-excited crystal phosphor rod system 110 with CPC beam shaper 113, a blue-light LED source 150 with CPC beam shaper 340, and a frequency-selective prism-assembly beam combiner 230 that uses an air gap 232 to promote total internal reflection (TIR) in the crystal phosphor rod system 110, according to some embodiments of the present invention, which shows another embodiment in which the frequency-selective optical filter-reflector 131 of FIG. 3 is replaced by prism-assembly beam combiner 230 (shown in FIG. 2) formed by two prisms 238 and 239 and a frequency-selective optical filter-reflector 236 between the prisms, passing the yellow light 118 and reflecting the blue light 158 from the blue LED 152 as shown in FIG. 2. Again, in some embodiments, the use of the beam combiner 230 reduces the dimensions of the components and system 400. In some embodiments, all six surfaces of the beam combiner 230 are optically polished to provide TIR at all surfaces, allowing efficient waveguide operations. Similar to the embodiment shown in FIG. 2, the air gap 232 is used to promote TIR such that the prism-assembly beam combiner 230 also acts as a waveguide, guiding the yellow and blue light from the inputs faces to the output face for coupling the output light 490 to the external applications. In some embodiments, the air gap 457 between the CPC 351 and the beam combiner 230 is similarly used to promote total internal reflections (TIR), such that the beam combiner 230 (shown in FIG. 2) further acts as a waveguide, guiding the yellow light from input face 233 and the blue light from input face 234 (see FIG. 2) to output face 235 (see FIG. 2) for coupling the combined output light 490 to the external applications.

FIG. 5A is a cross-sectional block diagram of a system 500 using a laser-excited crystal phosphor rod system 110 with CPC beam shaper 113, a blue-light laser source 550 with CPC beam shaper 340, and a frequency-selective filter-reflector beam combiner 130 that uses a frequency-selective optical filter-reflector 131, according to some embodiments of the present invention, which shows another embodiment of the system where the blue light 558, rather than being from one or more blue LEDs 152 as shown in FIGS. 1, 2, 3, and 4, is provided by one or more blue lasers 552. In some embodiments, diffuser 554 (and/or spatial filter 553) scatters the blue laser light such that it fills the input face of the CPC 351 more uniformly. As a result, in some embodiments, the output of the CPC 351 will be more uniform in intensity. Since the diffuser 554 would scatter light in both the forward and backward propagation directions, it is advantageous, in some embodiments, to reflect the backward-scattered light back to the forward output propagation direction. In some embodiments, an optional spatial filter 553, which has one or more apertures 556 (as shown in FIG. 5B), each corresponding to one of the one or more input blue laser beams 558, that allow the passing of the blue laser light upward onto the diffuser 554, but has reflective surface 557 (again, see FIG. 5B) across the rest of the area for reflecting backward-direction light back (upward) to the forward direction for increased efficiency.

FIG. 5B is a perspective block diagram of spatial filter 553, according to some embodiments of the invention. In some embodiments, spatial filter 553 has one or more apertures 556, each corresponding to one of the one or more input blue laser beams 558 of blue laser 552, that allow the passing of the blue laser light beams 558 upward through spatial filter 553 onto the diffuser 554, but has reflective surface 557 across the rest of the area for reflecting backward-direction light from diffuser 554 back to the forward direction for increased efficiency.

FIG. 6 is a cross-sectional block diagram of a system 600 using a laser-excited crystal phosphor rod system 110 with CPC beam shaper 113, a blue-light laser source 550 with CPC beam shaper 340, and a frequency-selective prism-assembly beam combiner 230 that uses an air gap 232 to promote total internal reflection (TIR) in the crystal phosphor rod system 110, according to some embodiments of the present invention, which shows another embodiment in which the frequency-selective filter-reflector beam combiner 130 of FIG. 5 is replaced by a prism-assembly beam combiner 230 (as described above for FIG. 2) formed by two prisms 238 and 239 and a frequency-selective optical filter layer 236 sandwiched between the prisms, passing the yellow light from crystal phosphor rod system 110 and reflecting the blue light from the blue laser assembly 550. The use of such beam combiner 230 reduces the dimensions of the components. Again, similar to that shown in FIG. 4, the air gap 457 is used to promote TIR such that the prism-assembly beam combiner 230 also acts as waveguides, guiding the yellow and blue light from the inputs faces to the output face for coupling the output beam 690 to the external applications. Other elements shown in FIG. 6 are as described above.

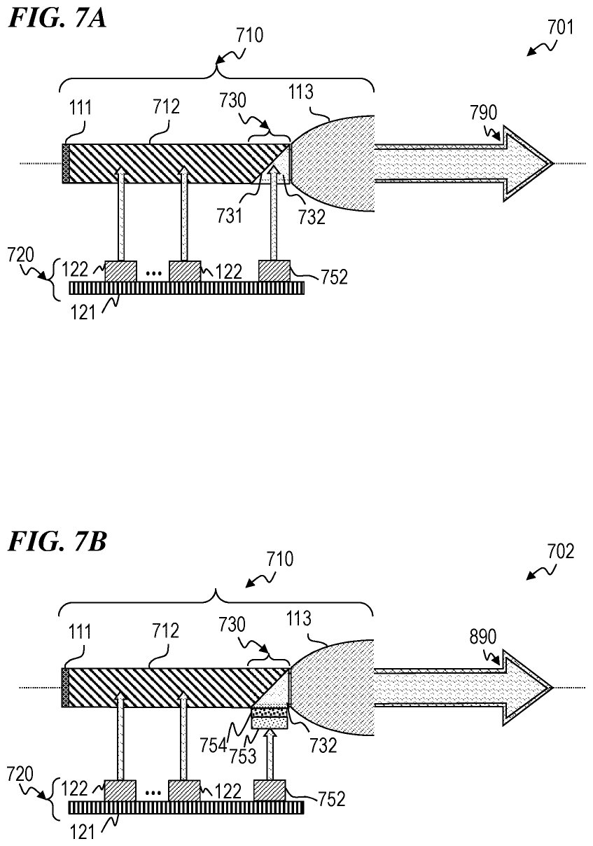

FIG. 7A is a cross-sectional block diagram of a system 701 using a laser-excited crystal phosphor rod system 710 with CPC beam shaper 113, a blue-light laser source array 720 (including a first plurality of one or more blue-light lasers 122 projecting their laser beams into crystal phosphor rod 712), and a frequency-selective filter-reflector beam combiner 730, according to some embodiments of the present invention, which shows another embodiment of this invention where the blue-light output produced by the one or more blue lasers 752 (projecting their laser beam(s) into angled clear-rod prism 732) is combined with the yellow-light output of crystal phosphor rod 712 using an angled clear-rod prism 732 as shown, which, in some embodiments where the index of refraction of the crystal phosphor rod 712 is the same or substantially the same as the index of refraction of the angled clear-rod prism 732, is a 45-degree angle prism polished on all three optical-interface sides, acting as the continuation of the crystal phosphor rod 712, but with a blue reflective coating 731 (which passes longer-wavelength (e.g., yellow) light and reflects shorter-wavelength (e.g., blue) light at the angled interface. In some embodiments, crystal phosphor rod 712 is substantially similar to crystal phosphor rod 112 of FIG. 1, except that the output face at the right-hand end (as shown in FIG. 7A) is angled (e.g., in some embodiments, at 45 degrees) to interface with glass prism (clear rod) 732. In some embodiments, blue-light laser source array 720 is substantially similar to blue-light laser source array 120 of FIG. 1, except that the blue light from the right-most blue laser(s) is used, without wavelength conversion, to add a selected amount of blue light to the output to achieve a desired color temperature of the output beam 790. The yellow light from the crystal phosphor rod 712 is guided by clear rod 732 to the CPC 113. The blue light from the laser(s) 752 is reflected by the frequency-selective filter-reflector 731 to combine with the yellow light from the crystal phosphor rod 712. Again, in some embodiments, an optional diffuser 754 and/or optional spatial filter 753 (see FIG. 7B) can be placed between the clear rod 732 and the CPC 113, such that the blue-light output profile will be substantially the same as the yellow-light output profile in propagation axis, size, shape and divergence angle. In some embodiments, one or more blue LEDs is/are used in place of blue laser(s) 752.

FIG. 7B is a cross-sectional block diagram of a system 702 using a laser-excited crystal phosphor rod system 710 with CPC beam shaper 113, a blue-light laser source array 720 with a diffuser 754 and/or spatial filter 753, and a frequency-selective filter-reflector beam combiner 730, according to some embodiments of the present invention. In some embodiments, diffuser 754 and/or spatial filter 753 are substantially similar to diffuser 554 and/or spatial filter 553, respectively, as shown and described for FIG. 5A and FIG. 5B, and provide substantially similar functions of spreading the laser beam(s) evenly across the input face of CPC 113 and reducing speckle when a plurality of lasers are used for laser source 752.

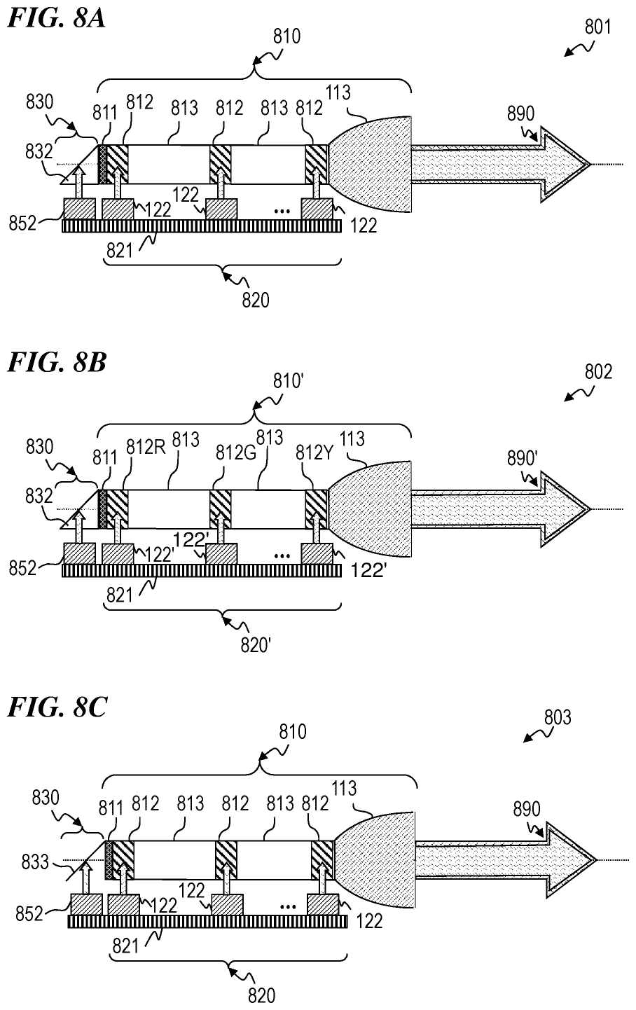

FIG. 8A is a cross-sectional block diagram of a system 801 using a laser-excited segmented crystal phosphor rod system 810 with CPC beam shaper 113, a blue-light laser source array 820 (including one or more blue-light lasers 122 mounted on a heat sink 821 projecting output into one or more layers of segments 812), and an optional blue laser source 852 (projecting output into and through prism reflector 832), and a frequency-selective filter-reflector 811, according to some embodiments of the present invention, which shows another embodiment in which laser-excited segmented crystal phosphor rod system 810 (in some embodiments, this can be considered to be a “one-dimensional” photonic crystal rod) is used to generate and combine blue laser output of lasers 122 and the phosphor-generated light output. In some embodiments, frequency-selective filter-reflector beam combiner 830 includes a right-angled prism 832 that is located at one end of system 801 (the left-hand end in FIG. 8A) where the blue-light output of the blue laser 852 is re-directed to the right-hand propagation direction toward the output of the system 801. In some embodiments, the rest of the composite rod 810 includes of one or more layers of clear crystal phosphor segments 812 separated by clear sections (e.g., in some embodiments, glass segments 813) such that each phosphor layer or segment 812 is excited by its corresponding blue laser(s) 122. An example system is shown in FIG. 8A with three phosphor layers/segments 812. In some embodiments, a blue-transmitting, yellow-reflecting frequency-selective optical filter-reflector 811 is placed between the right-angled prism 832 and the straight portion of the rod 812 such that all the yellow light that may start propagating leftward is reflected back rightward towards and into the output beam 890. The output of the blue laser 852 directed towards the prism 832 is reflected rightward towards the output propagation direction of system 801. The blue-light beam from laser 852 has to pass through one or more layers of phosphor 812, such that part of the output blue-light beam from laser 852 is converted to yellow light and the remaining blue light will contribute to the output beam 890. Each phosphor layer is excited by its corresponding blue laser(s) 122 and the yellow light that is directed towards the output 890 in one propagation direction (i.e., leftward) and reflected by wavelength-selective filter-reflector 811 back towards the output if it starts in the other propagation direction. Again, a CPC 113 is used to extract the output light from the composite rod system 810 having the output light beam 890 with a smaller divergence angle and larger area than the light emitted from composite rod system 810.

FIG. 8B is a cross-sectional block diagram of a system 802 using a laser-excited segmented crystal phosphor rod system 810′ (which uses segments 812R, 812G, and/or 812Y, each doped with different phosphors, which absorb blue light from lasers 122′ and down-convert the frequency of that light to different color wavelengths (with lower frequencies and longer wavelengths than the blue light), for example to red (e.g., in some embodiments, having a center wavelength of about 620 nm), green (e.g., in some embodiments, having a center wavelength of about 520 nm) or yellow (e.g., in some embodiments, having a center wavelength of about 580 nm)) with CPC beam shaper 113, a blue-light laser source array 820′ (in some embodiments, having independent lasers 122′, which respectively project output into segments 812R, 812G, and/or 812Y, and which are selectively driven individually and/or in groups using pulse electrical signals), and an additional blue laser source 852 and prism reflector 832 (wherein light from additional blue laser source 852 is diffused and projected into and through prism reflector 832), and frequency-selective filter-reflector 811, according to some embodiments of the present invention. As an alternative to, or addition to, the embodiment described above for FIG. 8A, other embodiments such as shown in FIG. 8B can also be configured to provide other colored output, since each layer or segment 812 of phosphor (e.g., in some embodiments, including segment 812R that absorbs blue laser light and emits red light, segment 812G that absorbs blue laser light and emits green light, and/or segment 812Y that absorbs blue laser light and emits yellow light) can be individually selected and/or tailored to provide light with one or more of a plurality of possible colors by using other colored phosphors such as those just described that absorb blue laser light and down-convert the frequency to longer-wavelengths of red, green, etc., or a broad spectrum that includes wavelengths from various shades of cyan, green, yellow, orange and/or red. When these different phosphors are used for phosphor segments 812R, 812G and/or 812Y, the output light beam 890′ will include a combination of the total emissions of the various wavelengths. In some embodiments, the lasers 122′ of laser array 820′ can also be individually driven sequentially, singly or in combinations, such that various colors in a sequence (in some embodiments, as pulses, output at a high-enough frequency such that the human eye does not see a flicker—e.g., in some embodiments, above 60 hertz) are produced (optionally each having a different selectable intensity) and a sequential color system can be implemented. For example, in some embodiments, the individual blue lasers are driven using pulsed electrical signals, such that a pulse of red light (from segment 812R driven from the leftmost blue laser 122′, having a duration selectively controlled to provide a desired amount of red light in the composite output beam 890′), a pulse of green light (from segment 812G driven from the middle blue laser 122′, having a duration selectively controlled to provide a desired amount of green light in the composite output beam 890′), a pulse of yellow light (from segment 812Y driven from the right-most blue laser 122′, having a duration selectively controlled to provide a desired amount of yellow light in the composite output beam 890′), and/or a pulse of blue light (from laser 852, mixed with red, green and yellow light from the spatial sequence of phosphors—arranged left to right in FIG. 8B—having a duration selectively controlled to provide a desired amount of blue-white light in the composite output beam 890′—such beam being formed by electrical pulses of various durations and/or timings that drive the respective blue lasers 122′ and 852)—generate the composite output beam 890′.

FIG. 8C is a cross-sectional block diagram of a system 802 using a laser-excited segmented crystal phosphor rod system 810 with CPC beam shaper 113, a blue-light laser source array 820 (projecting output into segments 812), and an additional blue laser source 852 (projecting output onto angled reflector 833), and a frequency-selective filter-reflector 811, according to some embodiments of the present invention, which shows another embodiment of the invention in which the right-angled prism 832 as shown in FIG. 8A and FIG. 8B is replaced by a 45-degree mirror 833 in FIG. 8C for reflecting the blue laser light towards the output of the “one-dimensional” photonic crystal rod 810. In some embodiments, other aspects of this embodiment are as described for FIG. 8A and/or 8B.

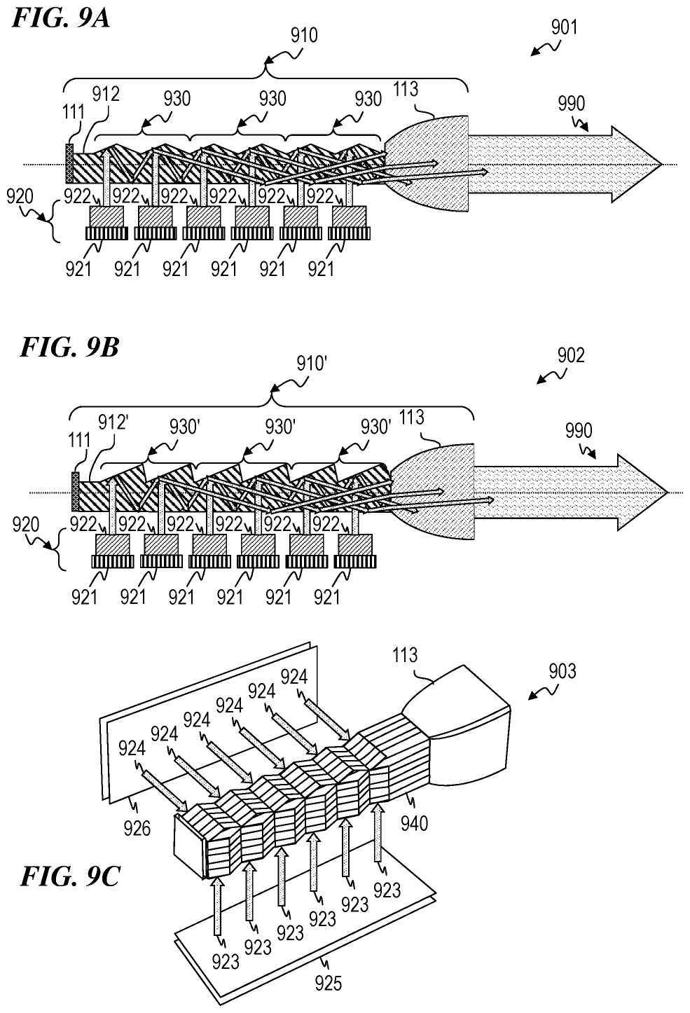

FIG. 9A is a cross-sectional block diagram of a system 901 using a laser-combining prism-top glass rod system 910 with CPC beam shaper 113, and a blue-light laser source array 920, according to some embodiments of the present invention. In some embodiments, glass light pipe 912 is used to collect and redirect the outputs from a plurality of lasers 922 into the output propagation direction (rightward in FIG. 9A). In some embodiments, a saw-tooth glass light pipe structure 912 having a plurality of saw-tooth pairs 930 is designed for the redirection of light such that total-internal-reflection (TIR) structures are used for simplicity in fabrication and increase in efficiency. In some embodiments, each laser 922 is mounted on a respective heat sink 921 (or in other embodiments (not shown), all on a common heat sink) and the laser-beam output of each laser 922 is directed vertically to the top-side facet on the left side of the initially encountered saw-tooth structure 930 such that it will be reflected towards the bottom side, then reflected to the left side facet of the next saw tooth but impinges that facet at a shallower angle such that the light is combined and propagates to the right at shallower and shallower angles, rightward in the light pipe 912 through total internal reflection. For example, the output of the leftmost laser 922, is directed vertically to the left side of the leftmost saw-tooth and reflected to the bottom of the light pipe 912. With total internal reflection, the light is then reflected back to the top to the left-hand facet of the second saw-tooth and reflected by this surface with total internal reflection towards the output of the light pipe at a shallower angle. Similarly, the output of the second laser 922 from the left, is reflected three times (by the left-hand facet of the second saw-tooth, by the bottom surface, and by the left-hand facet of the third saw-tooth), with the output directed towards the output (right-hand end) of the light pipe 912. The outputs of the other lasers 922 are similarly reflected and redirected rightward towards the output of the light pipe 912. A CPC 113 is used to confine the output divergence angle. In some embodiments, an optional diffuser, not shown, can be placed between the light pipe 912 and the CPC 113, increasing the uniformity of the output light-beam intensity. In various embodiments, the glass light pipe can have various refractive indices; for example, in some embodiments, glass having an index of refraction of 1.5, or, in other embodiments, high-index glass with an index of refraction of 1.82 can be used.

FIG. 9B is a cross-sectional block diagram of a system 902 using a laser-excited prism-top crystal phosphor rod system 910′ with CPC beam shaper 113, and a blue-light laser source array 920, according to some embodiments of the present invention. In some embodiments, asymmetrical saw-tooth shapes as shown are used at the top surface of light pipe 912′. In some embodiments, other aspects of the embodiment shown in FIG. 9B are the same as corresponding aspects of FIG. 9A.

FIG. 9C is a perspective block diagram of a system 903 using a laser-combining prism-top-and-side glass rod system 940 with CPC beam shaper 113, and blue-light laser source arrays 925 and 926, according to some embodiments of the present invention. In some embodiments, system 903 is similar in operation to system 901 of FIG. 9A, except that the V-groove prism structure is imposed on both the top side and front side, and the input laser arrays 925 and 926, respectively, input laser light 923 and 924, respectively, from both the bottom side and back side, respectively, of prism-top-and-side glass rod system 940.

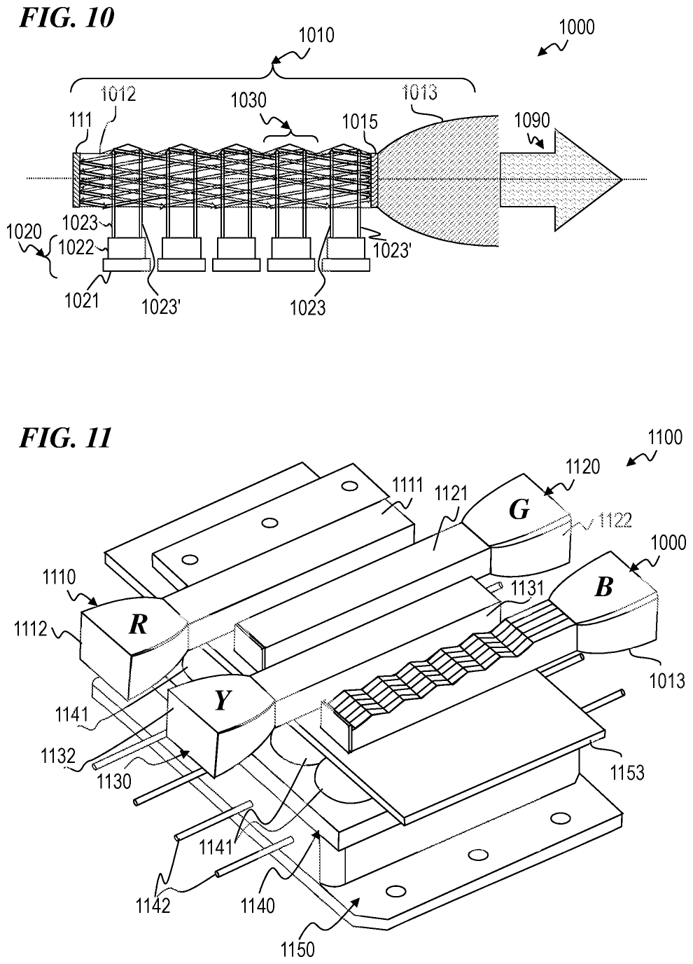

FIG. 10 is a cross-sectional block diagram of a blue-light system 1000 using a prism-top crystal rod system 1010 with CPC beam shaper 113, and a blue-light laser source array 1020, according to some embodiments of the present invention. In the embodiment of FIG. 10, a plurality of V-grooves 1030 is fabricated on the top side of the light pipe 1012. In some embodiments, for each V-groove 1030, one or more corresponding blue lasers 1022 (in some embodiments, each on a heat sink 1021, or in other embodiments (not shown, all on a common heat sink) are placed with the output of each laser 1022 directed across the center of the V-groove such that half of the beam is reflected to the left (e.g., laser light 1023′) and half of the beam is reflected to the right (e.g., laser light 1023). Both reflections are total internal reflections at the V-groove 1030. The reflections from the one side of the V-grooves 1030 (the right-hand side as shown in FIG. 10) are directed to the output of the light pipe directly. The reflections from the other side of the V-grooves 1030 (the left-hand side as shown in FIG. 10) are directed towards the left end of the light pipe where an end reflector 111 is placed to reflect all the light back (rightward) towards the output end of the light pipe 1012 through total internal reflections at the bottom of the light pipe. Similar to the embodiment shown in FIG. 9A, a CPC 1013 is used to confine the output divergence angle. In some embodiments, an optional diffuser and/or spatial light filter (not shown here, but similar in structure and function as diffuser 554 and spatial light filter 553 shown in FIG. 5A and FIG. 5B described above) is placed between the light pipe 1012 and the CPC 1013, increasing the uniformity of the output intensity.

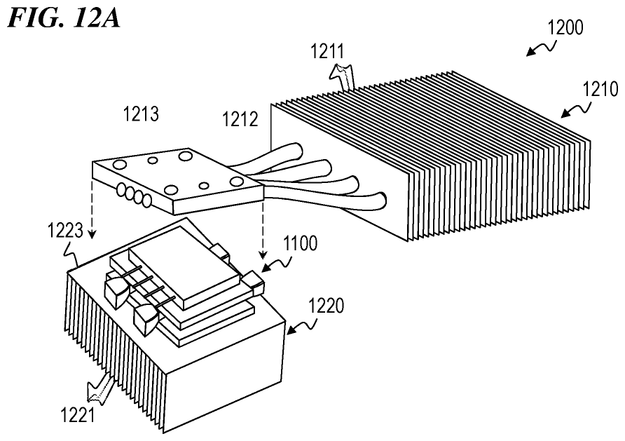

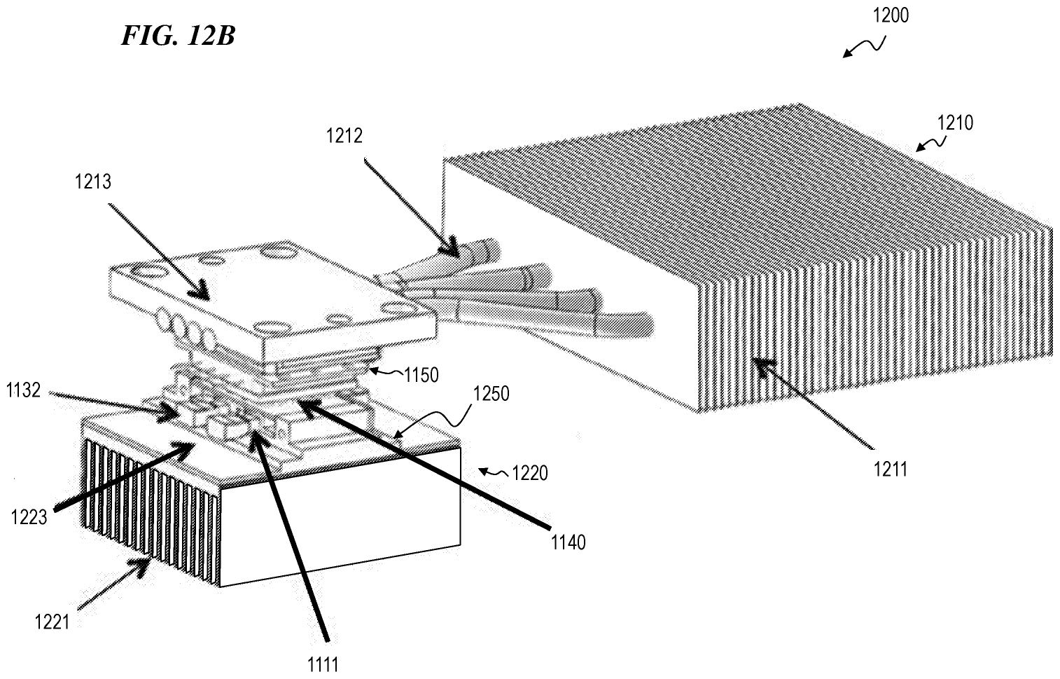

FIG. 11 is a perspective block diagram of a four-color light-source system 1100 using a blue-light system 1000 (such as described above and shown in FIG. 10), along with a plurality of crystal phosphor rod systems 1110, 1120, and 1130, each using blue-laser pumps and outputting different colors of light output, and each including its respective CPC beam shaper 1112, 1122, and 1132, and a common heat sink 1150, according to some embodiments of the present invention. (Some embodiments include a bottom-side heat sink 1150 and further include a similar heat sink (not shown here, but see heat-sink plate 1250 of FIG. 12B) on the top side as well.) In some embodiments, four-color light-source system 1100 includes a three-color laser-excited crystal phosphor rod system for red (crystal phosphor rod systems 1110), green (crystal phosphor rod systems 1120), and yellow (crystal phosphor rod systems 1130), along with the addition of the structured glass rod system 1000 for the blue-light output. In some embodiments, a two-dimensional (2D) four-by-six (4×6) laser array, having four (4) rows of six (6) lasers each is used to drive these three crystal phosphor rod systems 1110 (including crystal phosphor rod 1111 and CPC 1112), 1120 (including crystal phosphor rod 1121 and CPC 1122), and 1130 (including crystal phosphor rod 1131 and CPC 1132), and structured glass light pipe 1000 (as shown and described for FIG. 10), where each row of six lasers is used to excite the corresponding crystal phosphor rod system 1110, 1120, and 1130 and structured glass light pipe 1000. The red-light, green-light, yellow-light and blue-light outputs are all coupled out of the system using respective CPCs 1112, 1122, 1132 and 1013, as shown. In some embodiments, a combined diffuser/spatial-filter reflector 1153 substantially similar to diffuser 554 and spatial filter 553, as shown and described for FIG. 5A and FIG. 5B, and providing substantially similar functions, is placed between the laser array 1140 and the crystal phosphor rod systems 1110, 1120, and 1130 and blue-light system 1000, with apertures (such as apertures 556 of FIG. 5B) that pass the blue laser beams and a reflective surface (such as reflective surface 557 of FIG. 5B) to reflect downward-propagating light back into the respective crystal phosphor rod systems 1110, 1120, and 1130 and blue-light system 1000. In some embodiments, laser array 1140 includes a plurality of lasers 1141, as driven by electrical pins 1142, used to provide pump (laser) light into the respective crystal phosphor rod systems 1110, 1120, and 1130 and blue-light system 1000. In some embodiments, a four-by-six array of lasers is used such that six lasers drive each one of the respective crystal phosphor rod systems 1110, 1120, and 1130 and blue-light system 1000.

FIG. 12A is an exploded perspective block diagram of a four-color light-source system 1200 using a four-color light-source system 1100 and a plurality of heat sinks 1210 and 1220, according to some embodiments of the present invention. In some embodiments, four-color light-source system 1200 includes a top-side heat sink 1210 and a bottom-side heat sink 1220. In some embodiments, top-side heat sink 1210 includes a thermally conductive plate 1213 (such as a copper plate), a plurality of heat pipes 1212 used to convey heat to a plurality of fins 1211 (in some embodiments, fins 1211 are located remote from four-color light-source system 1100 to make it easier for routing of the output light, and a fan (not shown) is used to increase air flow across the fins 1211 to improve cooling). In some embodiments, bottom-side heat sink 1220 includes a thermally conductive plate 1223 (such as a copper plate), directly connected to a plurality of fins 1221 (in some embodiments, a fan (not shown) is used to increase air flow across the fins 1221 to improve cooling). In some embodiments, both the top-side and bottom-side heat sinks are implemented as heat sink 1210, while in other embodiments, both the top-side and bottom-side heat sinks are implemented as heat sink 1220.

FIG. 12B is a perspective block diagram of an assembled four-color light-source system 1200 using a four-color light-source system 1100 and a plurality of heat sinks 1210 and 1220, according to some embodiments of the present invention, which shows the complete structure of the system. Note that, as shown in FIG. 12B, four-color light-source system 1100 is up-side-down as compared to the view of FIG. 11. In some embodiments, the two-dimensional (2D) laser array 1140 is mounted on a heat sink 1210 with heat pipes 1212. The heat pipes 1212 transfer the heat very efficiently from the thermally conductive plate 1213 to a remote cooling fin system 1211 for efficient cooling. In other embodiments, other cooling methods, including active refrigeration using liquid transfer of heat from the laser heat sink 1150 (see FIG. 11) to the remotely located cooling fins, can be used. In some embodiments, fans are added to increase the efficiency of cooling. In some embodiments, a heat-sink plate 1250 (which, in some embodiments, is part of heat sink 1223) is in thermal contact with the opposite side of system 1100 as heat sink 1150. In some embodiments, the combined heat-sink plate 1250 and heat sink 1223 is in contact with the crystal phosphor rods and the structured glass light pipe such that the heat is transmitted away and cooled through the use of the cooling fins 1221. Fans can be added, not shown, for even more effective cooling increasing the efficiency of the system. Other elements shown are as described in the other figures, above in this description.

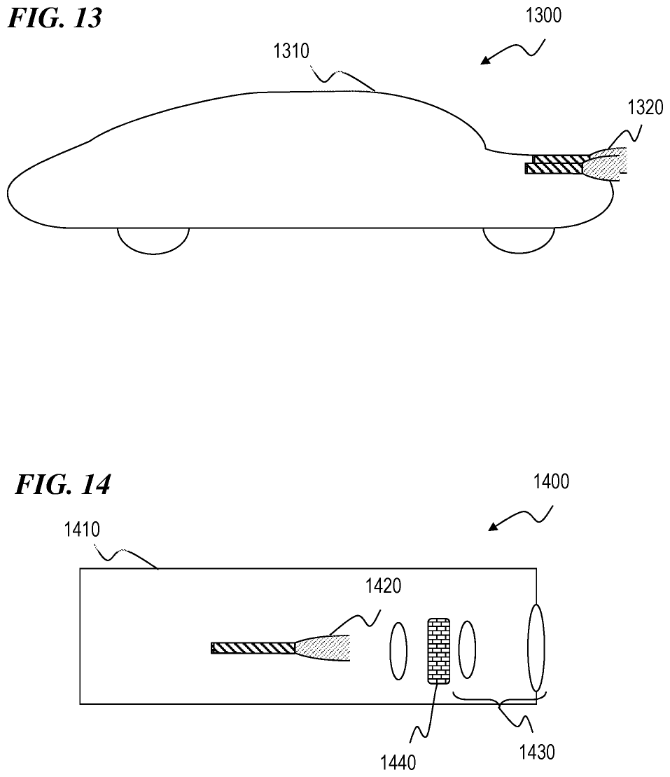

FIG. 13 is a block diagram of a vehicle system 1300 using a light-source system 1320 in a vehicle 1310, according to some embodiments of the present invention. In various embodiments, vehicle 1310 is an automobile, or a truck, or an aircraft such as a plane or helicopter or the like. In some such embodiments, light-source system 1320 includes one or more light-source systems such as described above and shown in FIGS. 1 through 12B.

FIG. 14 is a block diagram of an image-projection system 1400 using a light-source system 1420 in a projector 1410, according to some embodiments of the present invention. In various embodiments, projector 1410 is a movie projector, searchlight, stage light projector or the like. In some embodiments, projector 1410 includes one or more spatial light modulator(s) 1440 (such as Texas Instruments' DLP® DMD, LCD, LCOS or the like) and a lens system 1430. In some such embodiments, light-source system 1420 includes one or more light-source systems such as described above and shown in FIGS. 1 through 12B. In some embodiments, a plurality of spatial light modulators 1440, each respective one of the spatial light modulators 1440 being paired with a respective one of the colored output beams of a system 1100 of FIGS. 11, 12A and 12B.

As used herein, “blue light” includes wavelengths in a range from 400 nm to 500 nm that together appear blue to the human eye, “green light” includes wavelengths in a range from 500 nm to 570 nm that together appear green to the human eye, “narrow-band yellow light” includes wavelengths in a range from 570 nm to 590 nm, “broad-band yellow light” includes wavelengths in a range from 500 nm to 700 nm that together appear yellow to the human eye, “yellow light” includes “narrow-band yellow light” and/or “broad-band yellow light” that together appear yellow to the human eye, and “red light” includes wavelengths in a range from 600 nm to 700 nm that together appear red to the human eye.

As used herein, a “wavelength-selective optical filter” is synonymous with a “frequency-selective optical filter” when in the same index of refraction, wherein the wavelength of the light correlates inversely to the frequency of the light and to the index of refraction through which the light propagates. Since the frequency does not change upon a change in the index of refraction, the term “frequency-selective optical filter” is mostly used herein.

In some embodiments, the present invention provides a crystal phosphor rod light source (e.g., such as shown in FIGS. 1, 2, 3, 4, 5A, 5B, 6, 7A, 7B, 8A, 8B, and/or 8C) that includes: a heat sink; a first plurality of lasers, each mounted in thermal contact to the heat sink, wherein each of the first plurality of lasers emits laser light of one or more first wavelengths; a first crystal phosphor rod having a first end, a second end opposite the first end and at least one side face operatively coupled to receive the laser light of the one or more first wavelengths from one or more of the first plurality of lasers and to emit light of one or more second wavelengths, wherein each of the one or more second wavelengths is longer than the one or more first wavelengths; and a first compound parabolic concentrator (CPC) arranged to receive the light of the one or more second wavelengths from the second end of the first crystal phosphor rod, wherein the light source outputs a first output light beam that includes the light of one or more second wavelengths from the first crystal phosphor rod and light of the one or more first wavelengths.

In some embodiments of the crystal phosphor rod light source, the light of the one or more first wavelengths is blue in color.

In some embodiments of the crystal phosphor rod light source the light of the one or more second wavelengths is yellow in color.

In some embodiments of the crystal phosphor rod light source, the light of the one or more second wavelengths includes light that is red in color and light that is green in color.

Some embodiments of the crystal phosphor rod light source (such as shown in FIGS. 1 and 2) further include a blue LED light source that includes one or more LEDs that emit blue light including light of the one or more first wavelengths; a set of one or more lenses configured to collimate the blue light from the one or more LEDs that emit blue light; and a beam combiner that combines the blue light from the one or more LEDs that emit blue light with the light of one or more second wavelengths from the first crystal phosphor rod.

Some embodiments of the crystal phosphor rod light source (such as shown in FIG. 1) further include a blue LED light source that includes one or more LEDs that emit blue light including light of the one or more first wavelengths; a set of one or more lenses configured to collimate the blue light from the one or more LEDs that emit blue light; and a beam combiner that combines the blue light from the one or more LEDs that emit blue light with the light of one or more second wavelengths from the first crystal phosphor rod, wherein the beam combiner includes a frequency-selective optical filter-reflector that passes the light of the one or more second wavelengths and reflects light of the one or more first wavelengths.

Some embodiments of the crystal phosphor rod light source (such as shown in FIG. 2) further include a blue LED light source that includes one or more LEDs that emit blue light including light of the one or more first wavelengths; a set of one or more lenses configured to collimate the blue light from the one or more LEDs that emit blue light; and a beam combiner that combines the blue light from the one or more LEDs that emit blue light with the light of one or more second wavelengths from the first crystal phosphor rod, wherein the beam combiner includes a pair of prisms that sandwich a frequency-selective optical filter-reflector that passes the light of the one or more second wavelengths and reflects light of the one or more first wavelengths.

Some embodiments of the crystal phosphor rod light source (such as shown in FIGS. 3 and 4) further include a blue LED light source that includes one or more LEDs that emit blue light including light of the one or more first wavelengths; a second CPC arranged to receive the light from the blue LED light source and to output an intermediate light beam that includes the light of the one or more first wavelengths from the blue LED light source; and a beam combiner that combines the light from the second CPC and the light from the first CPC.

Some embodiments of the crystal phosphor rod light source (such as shown in FIG. 3) further include a blue LED light source that includes one or more LEDs that emit blue light including light of the one or more first wavelengths; a second CPC arranged to receive the light from the blue LED light source and to output an intermediate light beam that includes the light of the one or more first wavelengths from the blue LED light source; and a beam combiner that combines the blue light from the one or more LEDs that emit blue light with the light of one or more second wavelengths from the first crystal phosphor rod, wherein the beam combiner includes a frequency-selective optical filter-reflector that passes the light of the one or more second wavelengths and reflects light of the one or more first wavelengths.

Some embodiments of the crystal phosphor rod light source (such as shown in FIG. 4) further include a blue LED light source that includes one or more LEDs that emit blue light including light of the one or more first wavelengths; a second CPC arranged to receive the light from the blue LED light source and to output an intermediate light beam that includes the light of the one or more first wavelengths from the blue LED light source; and a beam combiner that combines the blue light from the one or more LEDs that emit blue light with the light of one or more second wavelengths from the first crystal phosphor rod, wherein the beam combiner includes a pair of prisms that sandwich a frequency-selective optical filter-reflector that passes the light of the one or more second wavelengths and reflects light of the one or more first wavelengths.

Some embodiments of the crystal phosphor rod light source (such as shown in FIG. 4) further include a blue LED light source that includes one or more LEDs that emit blue light including light of the one or more first wavelengths; a second CPC arranged to receive the light from the blue LED light source and to output an intermediate light beam that includes the light of the one or more first wavelengths from the blue LED light source, and a beam combiner that combines the blue light from the one or more LEDs that emit blue light with the light of one or more second wavelengths from the first crystal phosphor rod, wherein the beam combiner includes a pair of prisms that sandwich a frequency-selective optical filter-reflector that passes the light of the one or more second wavelengths and reflects light of the one or more first wavelengths, and wherein the light source is arranged such that there is an air gap between the first CPC and the beam combiner and such that there is an air gap between the second CPC and the beam combiner.

Some embodiments of the crystal phosphor rod light source (such as shown in FIGS. 5A, 5B and 6) further include a blue-light laser source that includes one or more lasers that emit blue light including light of the one or more first wavelengths; a second CPC arranged to receive the light from the blue laser light source and to output an intermediate light beam that includes the light of the one or more first wavelengths from the blue-light laser source; and a beam combiner that combines the light from the second CPC and the light from the first CPC.

Some embodiments of the crystal phosphor rod light source (such as shown in FIGS. 5A, 5B and 6) further include a blue-light laser source that includes one or more lasers that emit blue light including light of the one or more first wavelengths; a spatial filter-reflector that includes a reflective surface and one or more apertures through the reflective surface; a diffuser, wherein the one or more apertures of the spatial filter-reflector pass light from the one or more lasers of the blue-light laser source, and wherein the reflective surface reflects light backscattered from the diffuser; a second CPC arranged to receive the light from the diffuser and to output an intermediate light beam that includes the light of the one or more first wavelengths from the blue-light laser source; and a beam combiner that combines the light from the second CPC and the light from the first CPC.

Some embodiments of the crystal phosphor rod light source (such as shown in FIG. 5A) further include a blue-light laser source that includes one or more lasers that emit blue light including light of the one or more first wavelengths; a spatial filter-reflector that includes a reflective surface and one or more apertures through the reflective surface; a diffuser, wherein the one or more apertures of the spatial filter-reflector pass light from the one or more lasers of the blue-light laser source, and wherein the reflective surface reflects light backscattered from the diffuser; a second CPC arranged to receive the light from the diffuser and to output an intermediate light beam that includes the light of the one or more first wavelengths from the blue-light laser source; and a beam combiner that combines the blue light from the one or more LEDs that emit blue light with the light of one or more second wavelengths from the first crystal phosphor rod, wherein the beam combiner includes a frequency-selective optical filter-reflector that passes the light of the one or more second wavelengths and reflects light of the one or more first wavelengths.

Some embodiments of the crystal phosphor rod light source (such as shown in FIG. 6) further include a blue-light laser source that includes one or more lasers that emit blue light including light of the one or more first wavelengths; a spatial filter-reflector that includes a reflective surface and one or more apertures through the reflective surface; a diffuser, wherein the one or more apertures of the spatial filter-reflector pass light from the one or more lasers of the blue-light laser source, and wherein the reflective surface reflects light backscattered from the diffuser; a second CPC arranged to receive the light from the diffuser and to output an intermediate light beam that includes the light of the one or more first wavelengths from the blue-light laser source; and a beam combiner that combines the blue light from the one or more LEDs that emit blue light with the light of one or more second wavelengths from the first crystal phosphor rod, wherein the beam combiner includes a pair of prisms that sandwich a frequency-selective optical filter-reflector that passes the light of the one or more second wavelengths and reflects light of the one or more first wavelengths.

Some embodiments of the crystal phosphor rod light source (such as shown in FIG. 6) further include a blue-light laser source that includes one or more lasers that emit blue light including light of the one or more first wavelengths; a spatial filter-reflector that includes a reflective surface and one or more apertures through the reflective surface; a diffuser, wherein the one or more apertures of the spatial filter-reflector pass light from the one or more lasers of the blue-light laser source, and wherein the reflective surface reflects light backscattered from the diffuser; a second CPC arranged to receive the light from the diffuser and to output an intermediate light beam that includes the light of the one or more first wavelengths from the blue-light laser source; and a beam combiner that combines the blue light from the one or more LEDs that emit blue light with the light of one or more second wavelengths from the first crystal phosphor rod, wherein the beam combiner includes a pair of prisms that sandwich a frequency-selective optical filter-reflector that passes the light of the one or more second wavelengths and reflects light of the one or more first wavelengths, and wherein the light source is arranged such that there is an air gap between the first CPC and the beam combiner and such that there is an air gap between the second CPC and the beam combiner.

In some embodiments of the crystal phosphor rod light source (such as shown in FIG. 1), the first crystal phosphor rod includes a reflector mounted to the first end of the first crystal phosphor rod opposite the first CPC.

Some embodiments of the crystal phosphor rod light source (such as shown in FIGS. 7A and 7B) further include a clear rod having a first face oriented at an acute angle to a propagation direction of the first output beam, a second face substantially perpendicular to the propagation direction of the first output beam and a third face substantially perpendicular to the second face; and a source of blue light operatively coupled to direct the blue light into the clear rod through the third face, wherein the first crystal phosphor rod includes a reflector mounted to the first end of the first crystal phosphor rod, wherein the second end of the first crystal rod is angled at an acute angle to the propagation direction of the first output light beam, and connected to the first face of the clear rod with a frequency-selective optical filter located between the first crystal phosphor rod and the clear rod, and wherein the second face of the clear rod is connected to the first CPC.

Some embodiments of the crystal phosphor rod light source (such as shown in FIGS. 7A and 7B) further include a clear rod having a first face oriented at an acute angle to a propagation direction of the first output beam, a second face substantially perpendicular to the propagation direction of the first output beam and a third face substantially perpendicular to the second face; a source of one or more beams of blue laser light; a spatial filter-reflector that includes a reflective surface and one or more apertures through the reflective surface; and a diffuser, wherein the one or more apertures of the spatial filter-reflector pass light from the source of one or more beams of blue laser light, and wherein the reflective surface reflects light backscattered from the diffuser, wherein the diffuser is operatively coupled to direct the blue light into the clear rod through the third face, wherein the first crystal phosphor rod includes a reflector mounted to a first end of the first crystal phosphor rod, and wherein a second end of the first crystal phosphor rod, opposite the first end, is angled at an acute angle to the propagation direction of the first output light beam, and connected to the first face of the clear rod with a frequency-selective optical filter located between the first crystal phosphor rod and the clear rod, and wherein the second face of the clear rod is connected to the first CPC.

Some embodiments of the crystal phosphor rod light source (such as shown in FIGS. 8A, 8B and 8C) further include an angled reflector configured to direct blue light into the first end of the first crystal phosphor rod; a frequency-selective optical filter-reflector operatively coupled to the first end of the first crystal phosphor rod and configured to pass the blue light from the angle reflector and to reflect light of the one or more second wavelengths, wherein the first crystal phosphor rod includes a plurality of phosphor-doped segments alternating with a plurality of clear segments, and wherein the plurality of phosphor-doped segments each receive laser light from one or more of the first plurality of lasers.

Some embodiments of the crystal phosphor rod light source (such as shown in FIGS. 8A, 8B and 8C) further include an angled reflector configured to direct blue light into the first end of the first crystal phosphor rod; a frequency-selective optical filter-reflector operatively coupled to the first end of the first crystal phosphor rod and configured to pass the blue light from the angle reflector and to reflect light of the one or more second wavelengths, wherein the first crystal phosphor rod includes a plurality of phosphor-doped segments alternating with a plurality of clear segments, and wherein respective ones of the plurality of phosphor-doped segments each receive blue laser light from one or more respective ones of the first plurality of lasers and emit light of one of one or more of a plurality of different colors of wavelengths longer than the one or more first wavelengths from one or more of the first plurality of lasers.

In some embodiments of the crystal phosphor rod light source (such as shown in FIG. 8C), the angled reflector includes a mirror.

In some embodiments of the crystal phosphor rod light source (such as shown in FIGS. 8A and 8B), the angled reflector includes a prism.

Some embodiments of the crystal phosphor rod light source (such as shown in FIGS. 11, 12A and 12B) further include a second crystal phosphor rod having a first end, a second end opposite the first end and at least one side face operatively coupled to receive the laser light of the one or more first wavelengths from one or more of the plurality of lasers and to emit light of one or more third wavelengths, wherein each of the one or more third wavelengths is longer than the one or more first wavelengths and different than the one or more second wavelengths; and a second compound parabolic concentrator (CPC) arranged to receive the light of the one or more third wavelengths from the second end of the second crystal phosphor rod, wherein the light source outputs a second output light beam that includes the light of one or more third wavelengths from the second crystal phosphor rod and light of the one or more first wavelengths.

Some embodiments of the crystal phosphor rod light source (such as shown in FIGS. 11, 12A and 12B) further include a second crystal phosphor rod having a first end, a second end opposite the first end and at least one side face operatively coupled to receive the laser light of the one or more first wavelengths from one or more of the plurality of lasers and to emit light of one or more third wavelengths, wherein each of the one or more third wavelengths is longer than the one or more first wavelengths and different than the one or more second wavelengths; a second compound parabolic concentrator (CPC) arranged to receive the light of the one or more third wavelengths from the second end of the second crystal phosphor rod, wherein the light source outputs a second output light beam that includes the light of one or more third wavelengths from the second crystal phosphor rod and light of the one or more first wavelengths; a third crystal phosphor rod having a first end, a second end opposite the first end and at least one side face operatively coupled to receive the laser light of the one or more first wavelengths from one or more of the plurality of lasers and to emit light of one or more fourth wavelengths, wherein each of the one or more fourth wavelengths is longer than the one or more first wavelengths and different than the one or more second wavelengths and different than the one or more third wavelengths; and a third compound parabolic concentrator (CPC) arranged to receive the light of the one or more third wavelengths from the second end of the third crystal phosphor rod, wherein the light source outputs a third output light beam that includes the light of one or more fourth wavelengths from the third crystal phosphor rod and light of the one or more first wavelengths.

Some embodiments of another (e.g., secondary) light source of the present invention (such as shown in FIGS. 9A, 9B and 10) include a heat sink; a first plurality of lasers, each mounted in thermal contact to the heat sink, wherein each of the first plurality of lasers emit laser light of one or more first wavelengths; a first transparent rod having: a first end, a second end opposite the first end, at least a first planar side face operatively coupled to receive the laser light of the one or more first wavelengths from one or more of the first plurality of lasers, at least a first V-grooved side face opposite the first planar side face and having a plurality of V-shaped grooves, wherein each of the plurality of V-shaped grooves is configured to reflect light from one or more of the first plurality of lasers toward the first planar side face at a first oblique angle to the first face, wherein light then reflected from the first planar side face then impinges on another one of the V-shaped grooves at a second oblique angle shallower than the first oblique angle; and a first compound parabolic concentrator (CPC) arranged to receive the light of the one or more first wavelengths from the second end of the first transparent rod, wherein the light source outputs a first output light beam that includes the light of the first plurality of lasers.

Some embodiments of the secondary light source (such as shown in FIGS. 11, 12A and 12B) further include a first crystal phosphor rod having a first end, a second end opposite the first end and at least one side face operatively coupled to receive the laser light of the one or more first wavelengths from one or more of the first plurality of lasers and to emit light of one or more second wavelengths, wherein each of the one or more second wavelengths is longer than the one or more first wavelengths; a first compound parabolic concentrator (CPC) arranged to receive the light of the one or more second wavelengths from the second end of the first crystal phosphor rod, wherein the light source outputs a first output light beam that includes the light of one or more second wavelengths from the first crystal phosphor rod and light of the one or more first wavelengths; a second crystal phosphor rod having a first end, a second end opposite the first end and at least one side face operatively coupled to receive the laser light of the one or more first wavelengths from one or more of the plurality of lasers and to emit light of one or more third wavelengths, wherein each of the one or more third wavelengths is longer than the one or more first wavelengths and different than the one or more second wavelengths; a second compound parabolic concentrator (CPC) arranged to receive the light of the one or more third wavelengths from the second end of the second crystal phosphor rod, wherein the light source outputs a second output light beam that includes the light of one or more third wavelengths from the second crystal phosphor rod and light of the one or more first wavelengths; a third crystal phosphor rod having a first end, a second end opposite the first end and at least one side face operatively coupled to receive the laser light of the one or more first wavelengths from one or more of the plurality of lasers and to emit light of one or more fourth wavelengths, wherein each of the one or more fourth wavelengths is longer than the one or more first wavelengths and different than the one or more second wavelengths and different than the one or more third wavelengths; and a third compound parabolic concentrator (CPC) arranged to receive the light of the one or more third wavelengths from the second end of the third crystal phosphor rod, wherein the light source outputs a third output light beam that includes the light of one or more fourth wavelengths from the third crystal phosphor rod and light of the one or more first wavelengths.

In some embodiments, the present invention provides a crystal phosphor rod light source method that includes: cooling a first plurality of lasers each in thermal contact to a heat sink; emitting a first set of laser light beams from the first plurality of lasers, wherein each of the first set of laser light beams includes light of one or more first wavelengths; receiving the first set of laser light beams into a first crystal phosphor rod having a first end, a second end opposite the first end and at least one side face operatively coupled to receive the laser light of the one or more first wavelengths from one or more of the first plurality of lasers and to emit light of one or more second wavelengths, wherein each of the one or more second wavelengths is longer than the one or more first wavelengths; coupling the light of one or more second wavelengths into a first compound parabolic concentrator (CPC) arranged to receive the light of the one or more second wavelengths from the second end of the first crystal phosphor rod; and outputting, from the first CPC, a first output light beam that includes the light of one or more second wavelengths from the first crystal phosphor rod and additional light of the one or more first wavelengths.

Some embodiments of the method further include cooling the first crystal phosphor rod in thermal contact to a heat sink.

It is to be understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

1.-6. (canceled)

7. A crystal phosphor rod light source comprising:
a heat sink;
a first plurality of lasers, each mounted in thermal contact to the heat sink, wherein each of the first plurality of lasers emit laser light of one or more first wavelengths;
a first crystal phosphor rod having a first end, a second end opposite the first end and at least one side face operatively coupled to receive the laser light of the one or more first wavelengths from one or more of the first plurality of lasers and to emit light of one or more second wavelengths, wherein each of the one or more second wavelengths is longer than the one or more first wavelengths;
a first compound parabolic concentrator (CPC) arranged to receive the light of the one or more second wavelengths from the second end of the first crystal phosphor rod, wherein the light source outputs a first output light beam that includes the light of one or more second wavelengths from the first crystal phosphor rod and light of the one or more first wavelengths;
a blue LED light source that includes one or more LEDs that emit blue light including light of the one or more first wavelengths;
a set of one or more lenses configured to collimate the blue light from the one or more LEDs that emit blue light; and
a beam combiner that combines the blue light from the one or more LEDs that emit blue light with the light of one or more second wavelengths from the first crystal phosphor rod, wherein the beam combiner includes a pair of prisms that sandwich a frequency-selective optical filter-reflector that passes the light of the one or more second wavelengths and reflects light of the one or more first wavelengths.

8.-9. (canceled)

10. A crystal phosphor rod light source comprising:
a heat sink;
a first plurality of lasers, each mounted in thermal contact to the heat sink, wherein each of the first plurality of lasers emit laser light of one or more first wavelengths;
a first crystal phosphor rod having a first end, a second end opposite the first end and at least one side face operatively coupled to receive the laser light of the one or more first wavelengths from one or more of the first plurality of lasers and to emit light of one or more second wavelengths, wherein each of the one or more second wavelengths is longer than the one or more first wavelengths;
a first compound parabolic concentrator (CPC) arranged to receive the light of the one or more second wavelengths from the second end of the first crystal phosphor rod, wherein the light source outputs a first output light beam that includes the light of one or more second wavelengths from the first crystal phosphor rod and light of the one or more first wavelengths;
a blue LED light source that includes one or more LEDs that emit blue light including light of the one or more first wavelengths;
a second CPC arranged to receive the light from the blue LED light source and to output an intermediate light beam that includes the light of the one or more first wavelengths from the blue LED light source; and
a beam combiner that combines the blue light from the one or more LEDs that emit blue light with the light of one or more second wavelengths from the first crystal phosphor rod, wherein the beam combiner includes a pair of prisms that sandwich a frequency-selective optical filter-reflector that passes the light of the one or more second wavelengths and reflects light of the one or more first wavelengths.

11. The light source of claim 10,
wherein the light source is arranged such that there is an air gap between the first CPC and the beam combiner and such that there is an air gap between the second CPC and the beam combiner.

12. (canceled)

13. A crystal phosphor rod light source comprising:
a heat sink;
a first plurality of lasers, each mounted in thermal contact to the heat sink, wherein each of the first plurality of lasers emit laser light of one or more first wavelengths;
a first crystal phosphor rod having a first end, a second end opposite the first end and at least one side face operatively coupled to receive the laser light of the one or more first wavelengths from one or more of the first plurality of lasers and to emit light of one or more second wavelengths, wherein each of the one or more second wavelengths is longer than the one or more first wavelengths;
a first compound parabolic concentrator (CPC) arranged to receive the light of the one or more second wavelengths from the second end of the first crystal phosphor rod, wherein the light source outputs a first output light beam that includes the light of one or more second wavelengths from the first crystal phosphor rod and light of the one or more first wavelengths;
a blue-light laser source that includes one or more lasers that emit blue light including light of the one or more first wavelengths;
a spatial filter-reflector that includes a reflective surface and one or more apertures through the reflective surface;
a diffuser, wherein the one or more apertures of the spatial filter-reflector pass light from the one or more lasers of the blue-light laser source, and wherein the reflective surface reflects light backscattered from the diffuser;
a second CPC arranged to receive the light from the diffuser and to output an intermediate light beam that includes the light of the one or more first wavelengths from the blue-light laser source; and
a beam combiner that combines the light from the second CPC and the light from the first CPC.

14. The light source of claim 13,
wherein the beam combiner includes a frequency-selective optical filter-reflector that passes the light of the one or more second wavelengths and reflects light of the one or more first wavelengths.

15. The light source of claim 13,
wherein the beam combiner includes a pair of prisms that sandwich a frequency-selective optical filter-reflector that passes the light of the one or more second wavelengths and reflects light of the one or more first wavelengths.

16. The light source of claim 13,
wherein the beam combiner includes a pair of prisms that sandwich a frequency-selective optical filter-reflector that passes the light of the one or more second wavelengths and reflects light of the one or more first wavelengths, and wherein the light source is arranged such that there is an air gap between the first CPC and the beam combiner and such that there is an air gap between the second CPC and the beam combiner.

17. (canceled)

18. A crystal phosphor rod light source comprising:
a heat sink;
a first plurality of lasers, each mounted in thermal contact to the heat sink, wherein each of the first plurality of lasers emit laser light of one or more first wavelengths;
a first crystal phosphor rod having a first end, a second end opposite the first end and at least one side face operatively coupled to receive the laser light of the one or more first wavelengths from one or more of the first plurality of lasers and to emit light of one or more second wavelengths, wherein each of the one or more second wavelengths is longer than the one or more first wavelengths;
a first compound parabolic concentrator (CPC) arranged to receive the light of the one or more second wavelengths from the second end of the first crystal phosphor rod, wherein the light source outputs a first output light beam that includes the light of one or more second wavelengths from the first crystal phosphor rod and light of the one or more first wavelengths;
a clear rod having a first face oriented at an acute angle to a propagation direction of the first output beam, a second face substantially perpendicular to the propagation direction of the first output beam and a third face substantially perpendicular to the second face; and
a source of blue light operatively coupled to direct the blue light into the clear rod through the third face,
wherein the first crystal phosphor rod includes a reflector mounted to the first end of the first crystal phosphor rod,
wherein the second end of the first crystal rod is angled at an acute angle to the propagation direction of the first output light beam, and connected to the first face of the clear rod with a frequency-selective optical filter located between the first crystal phosphor rod and the clear rod, and
wherein the second face of the clear rod is connected to the first CPC.

19. A crystal phosphor rod light source comprising:
a heat sink;
a first plurality of lasers, each mounted in thermal contact to the heat sink, wherein each of the first plurality of lasers emit laser light of one or more first wavelengths;
a first crystal phosphor rod having a first end, a second end opposite the first end and at least one side face operatively coupled to receive the laser light of the one or more first wavelengths from one or more of the first plurality of lasers and to emit light of one or more second wavelengths, wherein each of the one or more second wavelengths is longer than the one or more first wavelengths;
a first compound parabolic concentrator (CPC) arranged to receive the light of the one or more second wavelengths from the second end of the first crystal phosphor rod, wherein the light source outputs a first output light beam that includes the light of one or more second wavelengths from the first crystal phosphor rod and light of the one or more first wavelengths;
a clear rod having a first face oriented at an acute angle to a propagation direction of the first output beam, a second face substantially perpendicular to the propagation direction of the first output beam and a third face substantially perpendicular to the second face;
a source of one or more beams of blue laser light;
a spatial filter-reflector that includes a reflective surface and one or more apertures through the reflective surface; and
a diffuser,
wherein the one or more apertures of the spatial filter-reflector pass light from the source of one or more beams of blue laser light, and wherein the reflective surface reflects light backscattered from the diffuser,
wherein the diffuser is operatively coupled to direct the blue light into the clear rod through the third face,
wherein the first crystal phosphor rod includes a reflector mounted to a first end of the first crystal phosphor rod, and
wherein a second end of the first crystal phosphor rod, opposite the first end, is angled at an acute angle to the propagation direction of the first output light beam, and connected to the first face of the clear rod with a frequency-selective optical filter located between the first crystal phosphor rod and the clear rod, and
wherein the second face of the clear rod is connected to the first CPC.

20. A crystal phosphor rod light source comprising:
a heat sink;
a first plurality of lasers, each mounted in thermal contact to the heat sink, wherein each of the first plurality of lasers emit laser light of one or more first wavelengths;
a first crystal phosphor rod having a first end, a second end opposite the first end and at least one side face operatively coupled to receive the laser light of the one or more first wavelengths from one or more of the first plurality of lasers and to emit light of one or more second wavelengths, wherein each of the one or more second wavelengths is longer than the one or more first wavelengths;
a first compound parabolic concentrator (CPC) arranged to receive the light of the one or more second wavelengths from the second end of the first crystal phosphor rod, wherein the light source outputs a first output light beam that includes the light of one or more second wavelengths from the first crystal phosphor rod and light of the one or more first wavelengths;
an angled reflector configured to direct blue light into the first end of the first crystal phosphor rod;
a frequency-selective optical filter-reflector operatively coupled to the first end of the first crystal phosphor rod and configured to pass the blue light from the angle reflector and to reflect light of the one or more second wavelengths,
wherein the first crystal phosphor rod includes a plurality of phosphor-doped segments alternating with a plurality of clear segments, and
wherein the plurality of phosphor-doped segments each receive laser light from one or more of the first plurality of lasers.

21. The light source of claim 20,
wherein respective ones of the plurality of phosphor-doped segments each receive blue laser light from one or more respective ones of the first plurality of lasers and emit light of one of one or more of a plurality of different colors of wavelengths longer than the one or more first wavelengths from one or more of the first plurality of lasers.

22. The light source of claim 21, wherein the angled reflector includes a mirror.

23. The light source of claim 21, wherein the angled reflector includes a prism.

24. (canceled)

25. A crystal phosphor rod light source comprising:
a heat sink;
a first plurality of lasers, each mounted in thermal contact to the heat sink, wherein each of the first plurality of lasers emit laser light of one or more first wavelengths;
a first crystal phosphor rod having a first end, a second end opposite the first end and at least one side face operatively coupled to receive the laser light of the one or more first wavelengths from one or more of the first plurality of lasers and to emit light of one or more second wavelengths, wherein each of the one or more second wavelengths is longer than the one or more first wavelengths;
a first compound parabolic concentrator (CPC) arranged to receive the light of the one or more second wavelengths from the second end of the first crystal phosphor rod, wherein the light source outputs a first output light beam that includes the light of one or more second wavelengths from the first crystal phosphor rod and light of the one or more first wavelengths;
a second crystal phosphor rod having a first end, a second end opposite the first end and at least one side face operatively coupled to receive the laser light of the one or more first wavelengths from one or more of the plurality of lasers and to emit light of one or more third wavelengths, wherein each of the one or more third wavelengths is longer than the one or more first wavelengths and different than the one or more second wavelengths;
a second compound parabolic concentrator (CPC) arranged to receive the light of the one or more third wavelengths from the second end of the second crystal phosphor rod, wherein the light source outputs a second output light beam that includes the light of one or more third wavelengths from the second crystal phosphor rod and light of the one or more first wavelengths;
a third crystal phosphor rod having a first end, a second end opposite the first end and at least one side face operatively coupled to receive the laser light of the one or more first wavelengths from one or more of the plurality of lasers and to emit light of one or more fourth wavelengths, wherein each of the one or more fourth wavelengths is longer than the one or more first wavelengths and different than the one or more second wavelengths and different than the one or more third wavelengths; and
a third compound parabolic concentrator (CPC) arranged to receive the light of the one or more third wavelengths from the second end of the third crystal phosphor rod, wherein the light source outputs a third output light beam that includes the light of one or more fourth wavelengths from the third crystal phosphor rod and light of the one or more first wavelengths.

26.-27. (canceled)

28. A light source comprising:
a heat sink;
a first plurality of lasers, each mounted in thermal contact to the heat sink, wherein each of the first plurality of lasers emit laser light of one or more first wavelengths;
a first transparent rod having:
a first end,
a second end opposite the first end,
at least a first planar side face operatively coupled to receive the laser light of the one or more first wavelengths from one or more of the first plurality of lasers,
at least a first V-grooved side face opposite the first planar side face and having a plurality of V-shaped grooves, wherein each of the plurality of V-shaped grooves is configured to reflect light from one or more of the first plurality of lasers toward the first planar side face at a first oblique angle to the first face, wherein light then reflected from the first planar side face then impinges on another one of the V-shaped grooves at a second oblique angle shallower than the first oblique angle; and
a first compound parabolic concentrator (CPC) arranged to receive the light of the one or more first wavelengths from the second end of the first transparent rod, wherein the light source outputs a first output light beam that includes the light of the first plurality of lasers.

29. The light source of claim 28, further comprising:
a first crystal phosphor rod having a first end, a second end opposite the first end and at least one side face operatively coupled to receive the laser light of the one or more first wavelengths from one or more of the first plurality of lasers and to emit light of one or more second wavelengths, wherein each of the one or more second wavelengths is longer than the one or more first wavelengths;
a first compound parabolic concentrator (CPC) arranged to receive the light of the one or more second wavelengths from the second end of the first crystal phosphor rod, wherein the light source outputs a first output light beam that includes the light of one or more second wavelengths from the first crystal phosphor rod and light of the one or more first wavelengths;
a second crystal phosphor rod having a first end, a second end opposite the first end and at least one side face operatively coupled to receive the laser light of the one or more first wavelengths from one or more of the plurality of lasers and to emit light of one or more third wavelengths, wherein each of the one or more third wavelengths is longer than the one or more first wavelengths and different than the one or more second wavelengths;
a second compound parabolic concentrator (CPC) arranged to receive the light of the one or more third wavelengths from the second end of the second crystal phosphor rod, wherein the light source outputs a second output light beam that includes the light of one or more third wavelengths from the second crystal phosphor rod and light of the one or more first wavelengths;
a third crystal phosphor rod having a first end, a second end opposite the first end and at least one side face operatively coupled to receive the laser light of the one or more first wavelengths from one or more of the plurality of lasers and to emit light of one or more fourth wavelengths, wherein each of the one or more fourth wavelengths is longer than the one or more first wavelengths and different than the one or more second wavelengths and different than the one or more third wavelengths; and
a third compound parabolic concentrator (CPC) arranged to receive the light of the one or more third wavelengths from the second end of the third crystal phosphor rod, wherein the light source outputs a third output light beam that includes the light of one or more fourth wavelengths from the third crystal phosphor rod and light of the one or more first wavelengths.

30. The light source of claim 29, further comprising:
a projector, wherein the projector uses the light source as part of an illumination system of the projector.

31.-32. (canceled)

33. The light source of claim 7, wherein the light of the one or more first wavelengths is blue in color, and wherein the light of the one or more second wavelengths is yellow in color.

34. The light source of claim 7, further comprising:
a vehicle, wherein the vehicle uses the light source as part of a headlight system of the vehicle.

35. The light source of claim 7, further comprising:
a projector, wherein the projector uses the light source as part of an illumination system of the projector.
